(19) United States
(12) Patent Application Publication
(10) Pub. No.: US 2008/0176120 A1
(43) Pub. Date: Jul. 24, 2008

(54) FUEL CELL WITH PROTECTIVE DEVICE

(76) Inventors: MING-YAO DONG, Chupei (TW); Chun-Chin Tung, Chupei (TW)

Correspondence Address: G. LINK CO., LTD., 3550 BELL ROAD, MINOOKA, IL, 60447, US

(21) Appl. No.: 12/017,802

(22) Filed: Jan. 22, 2008

(30) Foreign Application Priority Data
Jan. 24, 2007 (TW) 096102742

(51) Int. Cl. H01M 8/04

(52) U.S. Cl. 429/23; 429/12

(57) ABSTRACT

The present invention relates to a fuel cell with protective device, comprising a plurality of fuel cell stacks, a fuel cell protection circuit unit and a switch control device. The fuel cell protective circuit unit consists of a plurality of channel selection devices and a series-parallel circuit unit. The channel selection devices respectively correspond to one of the fuel cell stacks. The series-parallel circuit unit is electrically connected to the channel selection devices and has an electric output terminal. The fuel cell stacks are respectively electrically connected to the corresponding channel selection devices in the fuel cell protection circuit unit, and the switch control device controls the selection by the corresponding channel selection devices of an electrically open state or an electrically closed state between respective fuel cell stack and the series-parallel circuit unit.

### FIELD OF THE INVENTION

The present invention relates to a fuel cell with protective device, particularly a kind of fuel cell that provides a fuel cell protection circuit to protect the fuel cell stacks.

### BACKGROUND OF THE INVENTION

Convention fuel cell has a cell core that uses hydrogen-rich fuel (e.g. methanol) and oxygen fuel to undergo electrochemical reaction and output power. Fuel cells could be connected in series-parallel to a circuit to provide the electronic device with varying voltages and currents depending on different system demands. But when a fuel cell has been used for a long period of time or when the fuel supply of the fuel cell is incomplete, the reaction efficiency of the fuel cell might deteriorate to the point that the fuel cell output becomes insufficient. But because the fuel cell circuits are series-parallel connected, a single damaged fuel cell might accelerate the attrition of other working fuel cells.

In light that when fuel cells are series-parallel connected, and the damage of one fuel cell might affect the use of other fuel cells, the inventor aims to develop a fuel cell protection circuit that when a fuel cell deteriorates and becomes inadequate, this protection device of the fuel cell protects the fuel cell stacks that are still working from being affected.

In light of the drawbacks of conventional fuel cells, the inventor aims to develop a series-parallel circuit device for fuel cell.

### SUMMARY OF THE INVENTION

The object of the invention is to provide a fuel cell with protective device used in a fuel cell system with a plurality of fuel cell stacks and able to determine whether respective fuel cell stacks output power to a series-parallel circuit.

Another object of the invention is to provide a fuel cell with protective device used to determine whether respective fuel cell stack is in normal operating state and shut down the power output from fuel cell stacks that do not operate normally.

Yet another object of the invention is to provide a fuel cell with protective device used to integrate the power output by respective fuel cell stacks and output power with specific voltage or current via a series-parallel circuit.

To achieve the aforesaid objects, the invention provides a fuel cell with protective device, comprising a plurality of fuel cell stacks, a fuel cell protection circuit unit and a switch control device. The fuel cell protective circuit unit consists of a plurality of channel selection devices and a series-parallel circuit unit. The channel selection devices respectively correspond to one of the fuel cell stacks. The series-parallel circuit unit is electrically connected to the channel selection devices and has an electrical output terminal. The fuel cell stacks are respectively electrically connected to the corresponding channel selection devices in the fuel cell protection circuit unit, and the switch control device controls the selection of an electrically open or an electrically closed state between respective fuel cell stack and the series-parallel circuit unit by the corresponding channel selection device.

Thus, when any fuel cell stack is damaged or in any other condition, the protective device can select via the switch control device an electrically closed state between said fuel cell stack and the series-parallel circuit unit.

The objects, features and effects of the invention are described in detail below with embodiments in reference to the accompanying drawings.

### BRIEF DESCRIPTION OF THE DRAWINGS

FIG. 1 is a component diagram of the fuel cell with protective device according to a first embodiment of the invention;

FIG. 2 is a component diagram of the fuel cell with protective device according to a second embodiment of the invention;

FIG. 3 is a component diagram of the fuel cell with protective device according to a third embodiment of the invention;

FIG. 4 is a component diagram of the fuel cell with protective device according to a fourth embodiment of the invention;

FIG. 5 is a component diagram of the fuel cell with protective device according to a fifth embodiment of the invention; and

FIG. 6 is a component diagram of the fuel cell with protective device according to a sixth embodiment of the invention.

### DETAILED DESCRIPTION OF THE INVENTION

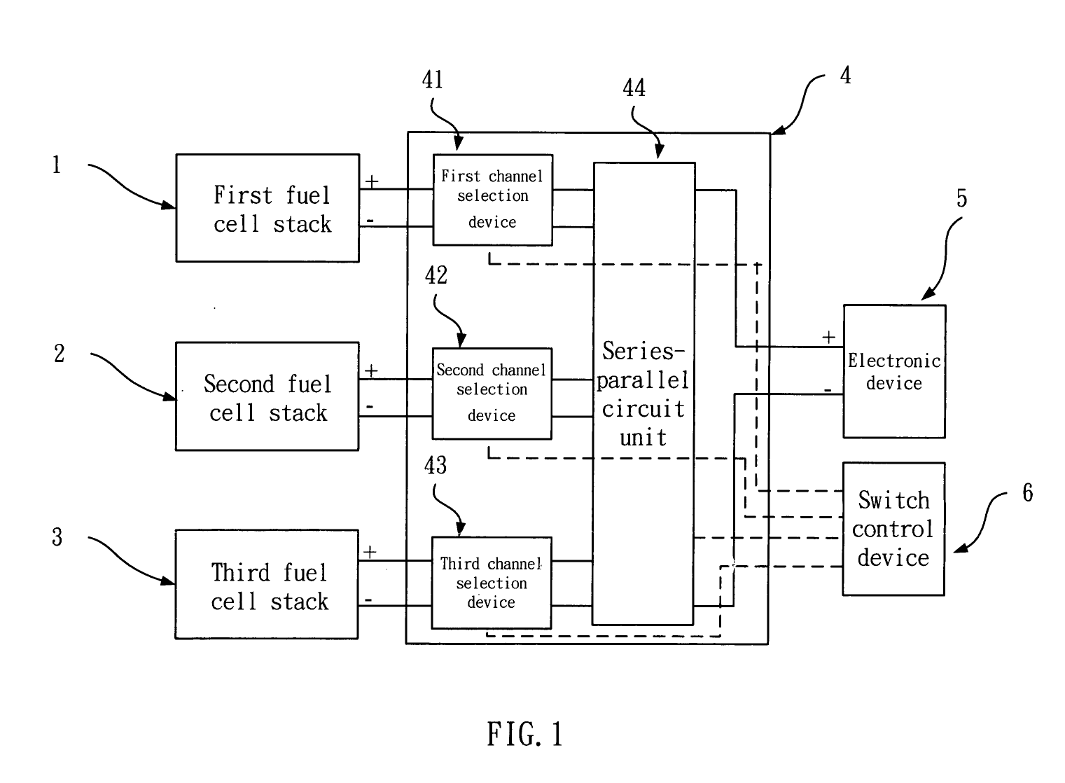

FIG. 1 is a component diagram of the fuel cell with protective device according to a first embodiment of the invention. As shown, the invention relates to a fuel cell with protective device comprising a plurality of fuel cell stacks including a first fuel cell stack (1), a second fuel cell stack (2), and a third fuel cell stack (3), electrically connecting the fuel cell stacks via a fuel cell protective circuit unit (4), transmitting the power output by the fuel cell stacks to an electronic device (5), and at the same time through a switch control device (6) controlling the fuel cell protective circuit unit (4) to select an electrically open state or an electrically closed state between respective fuel cell stack and the fuel cell protective circuit unit (4).

In the fuel cell with protective device of the invention, the first fuel cell stack (1), the second fuel cell stack (2), and the third fuel cell stack (3) each include a fuel cell power generation core for the operation of fuel cell and further generate power for output.

In the fuel cell with protective device of the invention, the fuel cell protective circuit unit (4) consists of a first channel selection device (41), a second channel selection device (42), a third channel selection device (43), and a series-parallel circuit unit (44). The first channel selection device (41), the second channel selection device (42), and the third channel selection device (43) are respectively electrically connected to the first fuel cell stack (1), the second fuel cell stack (2), and the third fuel cell stack (3). The series-parallel circuit unit (44) has serial-parallel connection means to enable the first fuel cell stack (1), the second fuel cell stack (2), and the third fuel cell stack (3) to be electrically connected to the series-parallel circuit unit (44) via the first channel selection device (41), the second channel selection device (42), and the third channel selection device (43) respectively. The series-parallel circuit unit (44) can, through each electric switch, select an electrically open state or an electrically closed state for the anode channel and cathode channel of the series-parallel circuit unit (44), thereby deciding the electrical serial-parallel connection relationship between said fuel cell stacks. The electrical output terminal of the series-parallel circuit unit (44) then integrates the power generated by the fuel cell stacks and outputs the power to the electronic device (5) to provide the power needed.

As such, by designing the electric output characteristics of the fuel cell stacks, such as choosing the first fuel cell stack (1), the second fuel cell stack (2), and the third fuel cell stack (3) to output respectively electric power with specific voltage, current or power, which, after electric connection via the series-parallel circuit unit (44), is integrated into power having another specific voltage, current or power for output to the electronic device (5). Changing the serial-parallel connection relationship between the fuel cell stacks by modifying the series-parallel circuit unit (44) can obtain power output with another electrical characteristic.

In the fuel cell with protective device of the invention, the switch control device (6) can select an electrically open state or an electrically closed state for the first channel selection device (41), the second channel selection device (42), and the third channel selection device (43), and further select an electrically open state or an electrically closed state between the first fuel cell stack (i), the second fuel cell stack (2), and the third fuel cell stack (3) respectively and the series-parallel circuit unit (44). Thus when any of first fuel cell stack (1), second fuel cell stack (2), and third fuel cell stack (3) is damaged or in any other condition, the switch control device (6) can select an electrically closed state between said fuel cell stack and the series-parallel circuit unit (44), in which, the switch control device (6) determines whether each fuel cell stack is in the preset operating state via the output current or voltage of the fuel cell stack, and based on which, decides whether to open or block the electric connection between the fuel cell stack and the series-parallel circuit unit (44).

The switch control device (6) can also determine the power demand of the electronic device (5), and based on which, control the on or off of the electric switches (41), (42) and (43) to select output or no output by each fuel cell stack so as to change the circuit topology of the series-parallel circuit unit (44), which would output power with specific voltage or current.

Based on the aforesaid fuel cell with protective device, the output of the membrane electrode assemblies of the fuel cell stacks are independent without influencing each other so as to protect the fuel cell stacks.

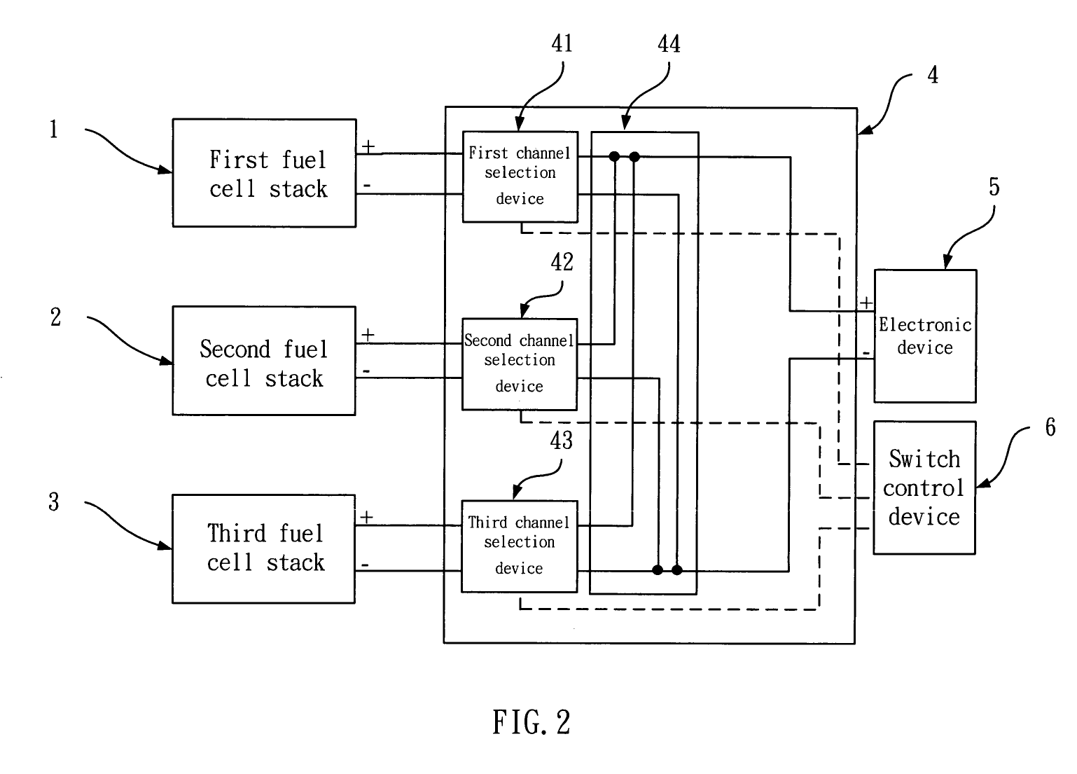

FIG. 2 is a component diagram of the fuel cell with protective device according to a second embodiment of the invention. The series-parallel circuit unit (44) in this embodiment is a logic circuit to which the fuel cell stacks are electrically and parallel-connected such that the switch control device (6) can select an electrically open or an electrically closed state for the first channel selection device (41), the second channel selection device (42), and the third channel selection device (43), thereby controlling the circuit topology of the series-parallel circuit unit (44). Specifically, when the switch control device (6) selects an electrically open state for the first channel selection device (41), the second channel selection device (42), and the third channel selection device (43) the first channel selection device (41), the second channel selection device (42), and the third channel selection device (43) are simultaneously electrically connected in parallel; when the switch control device (6) selects an electrically closed state for the first channel selection device (41) and an electrically open state for the second channel selection device (42) and the third channel selection device (43) the first channel selection device (41) disengages from the parallel connection loop in the series-parallel circuit unit (44), and only the second channel selection device (42) and the third channel selection device (43) are simultaneously electrically connected in parallel.

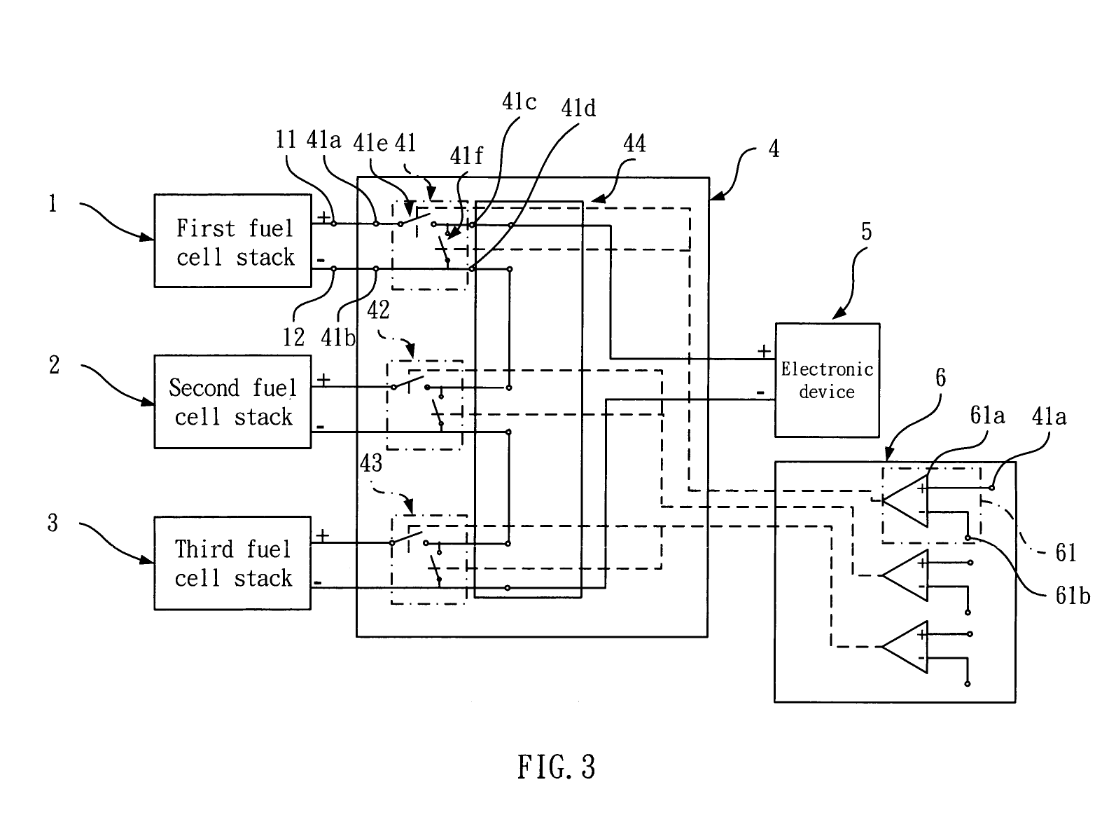

FIG. 3 is a component diagram of the fuel cell with protective device according to a third embodiment of the invention. The series-parallel circuit unit (44) in this embodiment is a logic circuit to which the fuel cell stacks are electrically and series-connected such that the switch control device (6) can select an electrically open state or an electrically closed state for the first channel selection device (41), the second channel selection device (42), and the third channel selection device (43), thereby controlling the circuit topology of the series-parallel circuit unit (44). Take the example of the first fuel cell stack (1) and the first channel selection device (41), the first channel selection device (41) comprises a first port (41a), a second port (41b), a third port (41c) and a fourth port (41d). The first fuel cell stack (1) is electrically connected to the first port (41a) and the second port (41b) through the first output terminal (11) and the second output terminal (12) respectively. The third port (41c) and the fourth port (41d) of the first channel selection device (41) are respectively electrically connected to the anode channel and the cathode channel of the series-parallel circuit unit (44). The second port (41b) and the fourth port (41d) of the first channel selection device (41) are electrically connected; the first port (41a) and the third port (41c) can be selected to be in an electrically open or closed state; the third port (41c) and the fourth port (41d) can be selected to be in an electrically open or closed state. The first output terminal (11) and the second output terminal (12) can be respectively the anode output terminal (11) and the cathode output terminal (12) of the first fuel cell (1); the first channel selection device (41) can select an electrically open state or an electrically closed state for those ports, that is, the first channel selection device (41) can select an electrically open state or an electrically closed state between the first fuel cell stack (1) and the fuel cell protection circuit unit (4). If it is electrically closed between the first fuel cell stack (1) and the fuel cell protection circuit unit (4), the electric loop of the fuel cell protection circuit unit (4) would bypass the electric section at where the first fuel cell stack (1) is located. Specifically, the first channel selection device (41) further contains a first switch element (41e) and a second switch element (41f), two ends of the first switch element (41e) being electrically connected to the first port (41a) and the third port (41f) respectively, two ends of the second switch element (41f) being electrically connected to the third port (41c) and the fourth port (41d) respectively, and the second port (41b) being directly electrically connected to the fourth port (41d). Thus when the switch control device (6) selects an electrically open state for the first switch element (41e) and an electrically closed state for the second switch element (41f), the first fuel cell stack (1) is electrically connected to the series-parallel circuit unit (44). When the switch control device (6) selects an electrically closed state for the first switch element (41e) and selects an electrically open state for the second switch element (41f), the first fuel cell stack (1) is electrically disconnected with the series-parallel circuit unit (44), and the third port (41c) and the fourth port (41d) are in short-circuit state. At the same time, the first fuel cell stack (1) will not input power into the series-parallel circuit unit (44), and the electric loop of the fuel cell protection circuit unit (4) would bypass the electric section at where the first fuel cell stack (1) is located, directly substitute it with the electric connection section of the third port (41c) and the fourth port (41d). Similarly, the four ports of the second channel selection device (42) and the third channel selection device (43) corresponding to the second fuel cell stack (2) and the third fuel cell stack (3) can be implemented in a manner as the four ports of the first channel selection device corresponding to the first channel selection device (41), or be substituted by other logic circuit and logic element.

In the embodiment above, the switch control device (6) includes an output determination unit (61) used to determine whether the output voltage or the output current of respective fuel cell stacks conforms to the design. Specifically, the output determination unit (61) of the switch control device (6) includes at least a comparator (61a) and a reference voltage (61b), the positive potential input terminal of the comparator (61a) being electrically connected to the first port (41a) of the first channel selection device (41), the negative potential input terminal of the comparator (61a) being electrically connected to the reference voltage (61b), and the reference voltage (61b) being provided for comparator (61a) to make comparison with the voltage at the first port (41a). Thus when the voltage at the first port (41a) is higher than the reference voltage (61b), the comparator (61a) would output a control signal to select an electrically open state for the first switch element (41e) of the first channel selection device (41) and an electrically closed state for the second switch element (41f) of the first channel selection device (41) to enable the first fuel cell stack (1) electrically connected with the series-parallel circuit unit (44) of the fuel cell protection circuit unit (4). When the voltage at the first port (41a) is lower than the reference voltage (61b), the comparator (61a) would output a control signal to select an electrically closed state for the first switch element (41e) of the first channel selection device (41) and an electrically open state for the second switch element (41f) of the first channel selection device (41) to enable the first fuel cell stack (1) electrically disconnected with the series-parallel circuit unit (44) of the fuel cell protection circuit unit (4). As such, the electric loop of the fuel cell protection circuit unit (4) would bypass the electric section at where the first fuel cell stack (1) is located, and directly substitute it with the electric connection section of the third port (41c) and the fourth port (41d) such that the first fuel cell stack (1) would be disengaged from the series loop of the series-parallel circuit unit (44) with only the second fuel cell stack (2) and the third fuel cell stack (3) being electrically connected to each other in series. Similarly, the switch control device (6) could include an output determination unit corresponding to the second fuel cell stack (2) and the third fuel cell stack (3) and control the second channel selection device (42) and the third channel selection device (43) to be in an electrically open or closed state. In addition, the value of the reference voltage (61b) of the comparator (61a) of output determination unit (61) can be a preset voltage or an adjustable voltage value, and the value could be the electrical property output by the corresponding fuel cell stack according to design and under normal operating condition. Moreover, the voltage value could be any designed value.

In respective channel selection devices, the switch element used is a MOS, transistor or other electronic switches.

In the aforesaid embodiment of fuel cell with protective device, the first fuel stack (1) provides a DC power. Thus the first switch element (41e) of the first channel selection device (41) could be electrically connected to the second output terminal (12) of the first fuel cell stack (1) at one end and electrically connected to the fourth port (41d) at the other end, the first port (41a) and the third port (41c) are electrically connected, and the third port (41c) and the fourth port (41d) are respectively corresponding and electrically connected to the anode channel and the cathode channel of the series-parallel circuit unit (44). The main idea is to use the electric switches of the first channel selection device (41) to select whether the first fuel cell stack (1) is electrically connected or disconnected with the anode channel and cathode channel of the series-parallel circuit unit (44). The same idea applies to other fuel cell stacks.

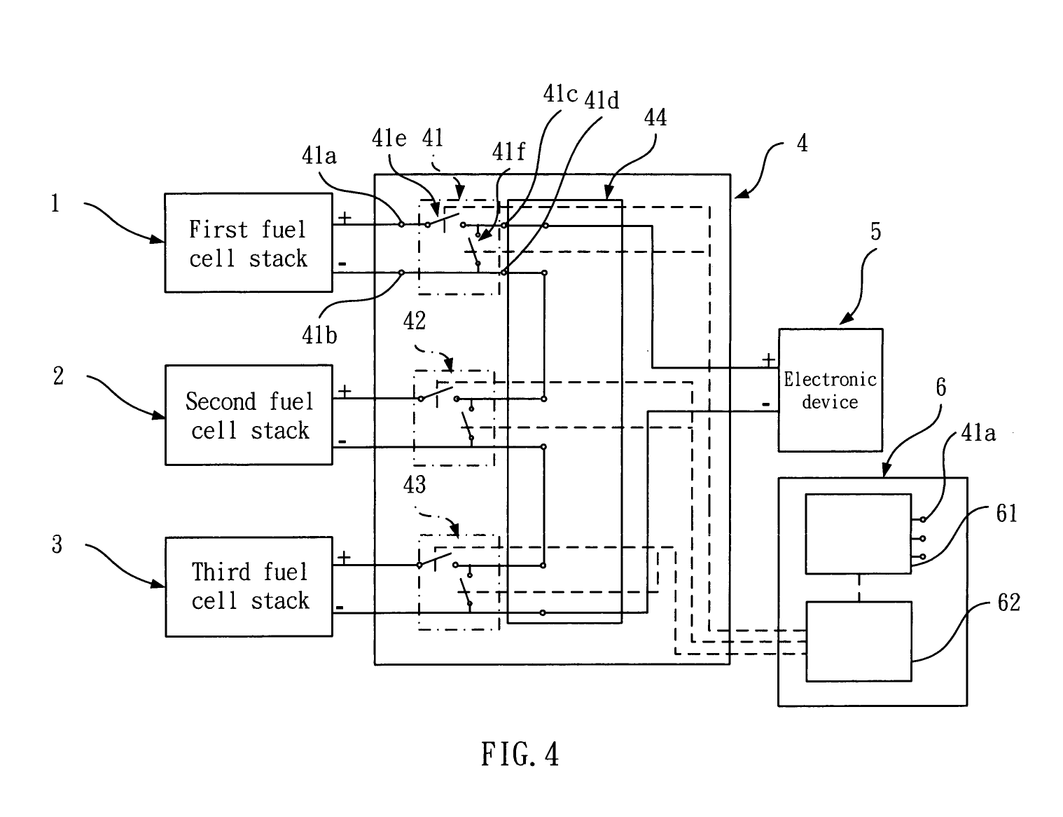

FIG. 4 is a component diagram of the fuel cell with protective device according to a fourth embodiment of the invention. In this embodiment, the switch control device (6) further includes a microcontroller (62), and the aforesaid output determination unit (61) can feedback the voltage value output or the output power state of the first fuel cell stack (1) to the microcontroller (62). The microcontroller (62), after logic determination, controls the first channel selection device (41) to select an electrically open state or an electrically closed state between the first fuel cell stack (1) and the series-parallel circuit unit (44) of the fuel cell protection circuit unit (4). Specifically, the microcontroller (62) stores the preset voltage output value of the first fuel cell stack (1). If the voltage at the first port (41a) as fed back by the output determination unit (61) is higher than this preset voltage output value, the microcontroller (62) would output a control signal to select an electrically open state for the first switch element (41e) of the first channel selection device (41) and an electrically closed state for the second switch element (41f) of the first channel selection device (41) such that the first fuel cell stack (1) is in an electrically open state with the series-parallel circuit unit (44) of the fuel cell protection circuit unit (4). If the voltage at the first port (41a) as fed back by the output determination unit (61) is lower than this preset voltage output value, the microcontroller (62) would output a control signal to select an electrically closed state for the first switch element (41e) of the first channel selection device (41) and an electrically open state for the second switch element (41f) of the first channel selection device (41) such that the first fuel cell stack (1) is in an electrically closed state with the series-parallel circuit unit (44) of the fuel cell protection circuit unit (4), and the electric loop of the of the fuel cell protection circuit unit (4) would bypass the electric section at where the first fuel cell stack (1) is located, and directly substitute it with the electric connection section of the third port (41c) and the fourth port (41d) such that the first fuel cell stack (1) would be disengaged from the series loop of the series-parallel circuit unit (44) with only the second fuel cell stack (2) and the third fuel cell stack (3) being electrically connected to each other in series. Similarly, the switch control device (6) could include an output determination unit corresponding to the second fuel cell stack (2) and the third fuel cell stack (3) and control the second channel selection device (42) and the third channel selection device (43) to be in electrically open or closed state via the microcontroller (62). The microcontroller (62), upon receiving the output voltage value from the output determination unit (61) corresponding to respective fuel cell stack, can engage in other controls based on the built-in logic computing program, not necessarily just the control of the corresponding channel selection device of the fuel cell stacks.

Moreover, the output determination unit (61) can, after comparing the output voltage value of respective fuel cell stack with its preset voltage output value, transmit the comparison result to the microcontroller (62).

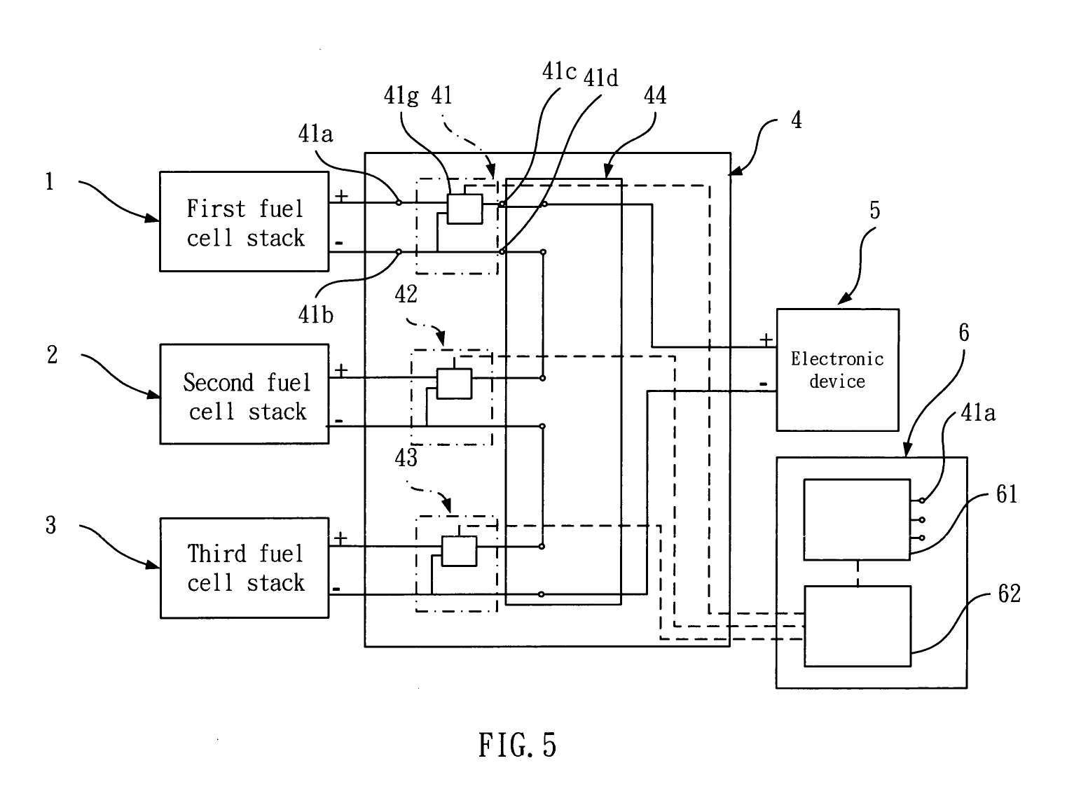

FIG. 5 is a component diagram of the fuel cell with protective device according to a fifth embodiment of the invention. In this embodiment, multiplexer is used to select whether the channel selection device corresponding to respective fuel cell stacks is in an electrically open or closed state. Specifically, the first channel selection device (41) corresponding to the first fuel cell stack (1) includes a multiplexer (41g), the multiplexer (41g) can select an electrically open state between the first port (41a) and the third port (41c), and an electrically closed state between the third port (41c) and the fourth port (41d), or select an electrically closed state between the first port (41a) and the third port (41c) and an electrically open state between the third port (41c) and the fourth port (41d). As such, the microcontroller (62) of the switch control device (6) can be used to control the channel switching by multiplexer (41g) so as to select an electrically open or closed state between the first fuel cell stack (1) and the series-parallel circuit unit (44) of the fuel cell protection circuit unit (4).

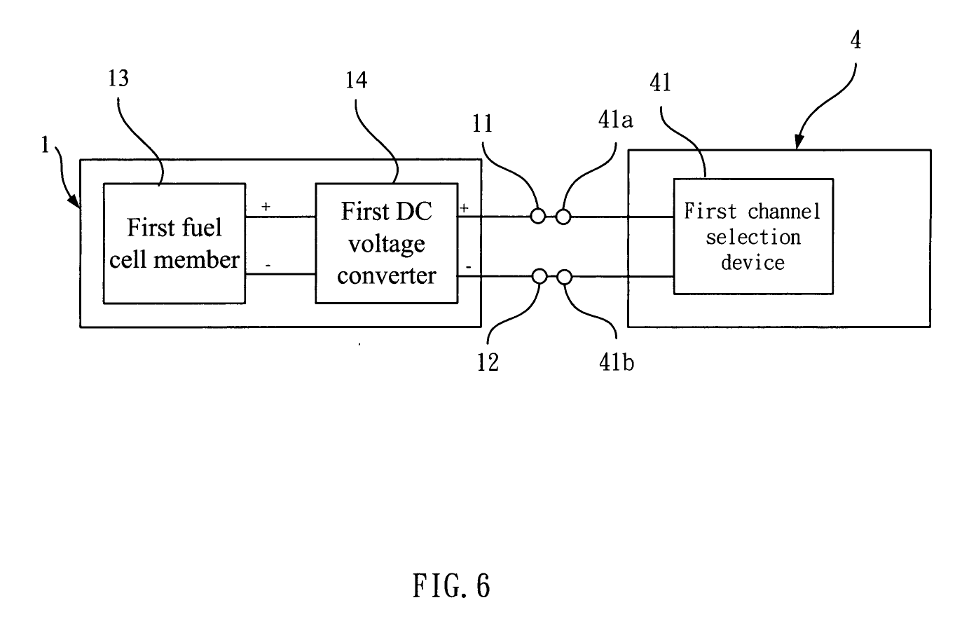

FIG. 6 is a partial component diagram of the fuel cell series-parallel circuit according to a sixth embodiment of the invention. In the plurality of fuel cell stacks, any fuel cell stack can include a fuel cell member and a DC voltage conversion unit corresponding to the fuel cell member. Specifically, the first fuel cell stack (1) can include a fuel cell member (13) and a first DC voltage conversion unit (14), the first cell member (13) being electrically connected to the first DC voltage conversion unit (14) and respectively electrically connected to the first port (41a) and the second port (41b) of the first channel selection device (41) of the fuel cell protection circuit unit (4) via the first output terminal (11) and the second output terminal (12) of the first fuel cell stack (1) such that the first fuel cell stack (1) electrically outputs to the fuel cell protection circuit unit (4). The first fuel cell member (13) of the first fuel cell stack (1) is the power generation core of the fuel cell used to engage in electrochemical reaction and output power to the first DC voltage conversion unit (14). The first DC voltage conversion unit (12) of the first fuel cell stack (1) is a direct-current voltage converter used to convert the DC power output by the first fuel cell stack (1) into power with specific voltage and transmit it to the first channel selection device (41) of the fuel cell protection circuit unit (4).

Based on the embodiments described above, any fuel cell stack in the plurality of fuel cell stacks can convert the power output by the fuel cell member into power with specific voltage via the DC voltage conversion unit, and determine, via the corresponding channel selection device, whether to input the power from the corresponding fuel cell stack into the fuel cell protection circuit unit so as to adjust the power voltage integrally output by the fuel cell protection circuit unit.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cell with protective device, comprising:
a plurality of fuel cell stacks;
a fuel cell protection circuit unit consisting of a plurality of channel selection devices and a series-parallel circuit unit, the channel selection devices being respectively corresponding to one of the fuel cell stacks, the series-parallel circuit unit being electrically connected to the channel selection devices and having an electrical output terminal; and
a switch control device;
wherein the fuel cell stacks are respectively electrically connected to the corresponding channel selection devices in the fuel cell protection circuit unit, and the switch control device is electrically connected to respective channel selection devices and controlling the selection by the channel selection devices of an electrically open state or an electrically closed state between the corresponding fuel cell stack and the series-parallel circuit unit.

2. The fuel cell with protective device according to claim 1, wherein the plurality of fuel cell stacks include a first fuel cell stack, and the plurality of channel selection devices include a channel selection device consisting of a first port a second port, a third port and a fourth port;
wherein the first fuel cell stack includes a first output terminal and a second output terminal, the first output terminal and the second output terminal being respectively electrically connected to the first port and the second port of the first channel selection device; the third port and the fourth port of the first channel selection device being respectively electrically connected to the series-parallel circuit unit; the second port being electrically connected to the fourth port; and the switch control device controlling the selection by the first channel selection device of an electrically open state between the first port and the third port, and an electrically closed state between the third port and the fourth port, or controlling the selection by the first channel selection device of an electrically closed state between the first port and the third port, and an electrically open state between the third port and the fourth port.

3. The fuel cell with protective device according to claim 2, wherein the first channel selection device further comprises a first switch element and a second switch element, the first switch element being electrically connected to the first port at one end and electrically connected to the third port at the other end, the second switch element being electrically connected to the third port at one end and electrically connected to the fourth port at the other end;
wherein the switch control device controls the selection by the first switch element of the first channel selection device of an electrically open state between the first port and the third port and controlling the selection by the second switch element of the first channel selection device of an electrically closed state between the third port and the fourth port, or the switch control device controls the selection by the first switch element of the first channel selection device of an electrically closed state between the first port and the third port, and controls the selection by the second switch element of an electrically open state between the third port and the fourth port such that the electrically open states of the first switch element and the second switch element are mutually exclusive.

4. The fuel cell with protective device according to claim 3, wherein the first switch element and the second switch element are a MOS or a transistor.

5. The fuel cell with protective device according to claim 2, wherein the switch control device further comprises an output determination unit for detecting the characteristics of power output by the first fuel cell stack.

6. The fuel cell with protective device according to claim 5, wherein the output determination unit of the switch control device consists of a comparator and a reference voltage, the positive potential input terminal of the comparator being electrically connected to the first port of the first channel selection device, the negative potential input terminal of the comparator being electrically connected to the reference voltage, the output terminal of the comparator being electrically connected to the first channel selection device;
wherein the comparator of the switch control device controls the selection by the first channel selection device of an electrically open state or an electrically closed state between the first fuel cell stack and the series-parallel circuit unit.

7. The fuel cell with protective device according to claim 6, wherein the value of the reference voltage of comparator is a preset voltage or an adjustable voltage value.

8. The fuel cell with protective device according to claim 2, wherein the first channel selection device further includes a multiplexer, the multiplexer selects an electrically open state between the first port and the third port, and an electrically closed state between the third port and the fourth port, or selects an electrically closed state between the first port and the third port, and an electrically open state between the third port and the fourth port.

9. The fuel cell with protective device according to claim 2, wherein the first fuel cell stack includes a first fuel cell member and a first DC voltage conversion unit, the DC voltage conversion unit being a DC voltage converter, the first fuel cell member being a fuel cell power generation core;
wherein the first cell member is electrically connected to the first DC voltage conversion unit, the first DC voltage conversion unit converting the DC power output by the first fuel cell stack into power with specific voltage for output, and the first fuel cell stack being electrically connected to the first port and the second port of the first channel selection device of fuel cell protection circuit unit.

10. The fuel cell with protective device according to claim 2, wherein the first fuel cell stack includes a power detection means for detecting the current or voltage output by the first fuel cell stack and providing information to the switch control device for controlling the selection by the first channel selection device of an electrically open state or an electrically closed state between the first fuel cell stack and the series-parallel circuit unit.

11. The fuel cell with protective device according to claim 1, wherein the switch control device further includes a microcontroller, the microcontroller controlling the selection by the first channel selection device of an electrically open state or an electrically closed state between the first fuel cell stack and the series-parallel circuit unit of the fuel cell protection circuit unit.

12. The fuel cell with protective device according to claim 11, wherein the microcontroller receives the output voltage value of respective fuel cell stacks from the output determination unit and controls the fuel cell with protective device according to the built-in logic computing program.

13. The fuel cell with protective device according to claim 11, wherein the output determination unit compares the voltage value output by respective fuel cell stacks with the preset voltage output, and the microcontroller, based on the comparison result, controls the selection by the first channel selection device of an electrically open state or an electrically closed state between the first fuel cell stack and the series-parallel circuit unit of the fuel cell protection circuit unit.

14. The fuel cell with protective device according to claim 11, wherein the switch control device further contains an output determination unit for detecting the characteristics of power output by the first fuel cell stack;
wherein the microcontroller, based on the characteristics of power output by the first fuel cell stack and detected by the output determination unit controls the selection by the first channel selection device of an electrically open state or an electrically closed state between the first fuel cell stack and the series-parallel circuit unit of the fuel cell protection circuit unit.

15. The fuel cell with protective device according to claim 11, wherein the output determination unit transmits a message of the voltage value output by the first fuel cell stack being greater than a preset voltage output value or a message of the voltage value output by the first fuel cell stack being smaller than a preset voltage output value to the microcontroller, and based on said message, the microcontroller controls the selection by the first channel selection device of an electrically open state or an electrically closed state between the first fuel cell stack and the series-parallel circuit unit of the fuel cell protection circuit unit.

16. The fuel cell with protective device according to claim 15, wherein the output determination unit of the switch control device consists of a comparator and a reference voltage, the positive potential input terminal of the comparator being electrically connected to the first port of the first channel selection device, the negative potential input terminal of the comparator being electrically connected to the reference voltage, the output terminal of the comparator being electrically connected to the microcontroller;
wherein the reference voltage is a preset voltage output value, and the comparator of the output determination unit transmits a message of the voltage value output by the first fuel cell stack being greater than the preset voltage output value or a message of the voltage value output by the first fuel cell stack being smaller than the preset voltage output value to the microcontroller.

17. The fuel cell with protective device according to claim 16, wherein the value of the reference voltage of comparator is a preset voltage or an adjustable voltage value.

18. The fuel cell with protective device according to claim 1, wherein the series-parallel circuit unit being electrically parallel-connected to the logic circuit of the fuel cell stack.

19. The fuel cell with protective device according to claim 1, wherein the series-parallel circuit unit being electrically series-connected to the logic circuit of the fuel cell stack.

20. The fuel cell with protective device according to claim 1, wherein the first fuel cell stack includes a first fuel cell member and a first DC voltage conversion unit, the DC voltage conversion unit being a DC voltage converter the first fuel cell member being a fuel cell power generation core;
wherein the first cell member is electrically connected to the first DC voltage conversion unit, the first DC voltage conversion unit converting the DC power output by the first fuel cell stack into power with specific voltage for output, and the first fuel cell stack being electrically connected to the first port and the second port of the first channel selection device of fuel cell protection circuit unit.
